(19) United States
(12) Patent Application Publication
(10) Pub. No.: US 2006/0238820 A1
(43) Pub. Date: Oct. 26, 2006

(54) Techniques for composing and sending a broadcast fax

(75) Inventors: Hubert Van Hoof, Seattle, WA (US); Timothy D. Sellers, Bellevue, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/112,978

(22) Filed: Apr. 22, 2005

(51) Int. Cl. H04N 1/00

(52) U.S. Cl. 358/400; 358/402

(57) ABSTRACT

Techniques for composing and sending a broadcast fax are described. One technique allows a user to designate a plurality of fax recipients to receive fax content. The method also creates a plurality of customized faxes which contain the fax content.

### TECHNICAL FIELD

The invention pertains to techniques for composing and sending faxes.

### BACKGROUND

Fax use continues to grow worldwide. Similarly, computer use continues to grow worldwide. Often fax users also are computer users or are potential computer users. Despite this overlap between fax use and computer use many fax users continue to utilize non-computer-based faxing. As such, a market exists for an enhanced computer-based fax experience.

### SUMMARY

Techniques for composing and sending a broadcast fax are described. One technique allows a user to designate a plurality of fax recipients to receive fax content. The method also creates a plurality of customized faxes which contain the fax content.

### BRIEF DESCRIPTION OF THE DRAWINGS

FIG. 1 illustrates a user-interface supporting an enhanced fax functionality, in accordance with one embodiment.

FIG. 2 illustrates a system supporting an enhanced fax functionality, in accordance with one embodiment.

FIG. 3 illustrates a system component supporting an enhanced fax functionality, in accordance with one embodiment.

FIGS. 4-8 illustrate screenshots of an enhanced fax functionality, in accordance with one embodiment.

FIGS. 9-13 illustrate screenshots of an enhanced fax functionality relating to broadcast faxing, in accordance with one embodiment.

FIG. 14 illustrates exemplary systems, devices, and components in an operating environment which can support broadcast faxing, in accordance with one embodiment.

FIG. 15 illustrates an exemplary process diagram in which broadcast faxing can be implemented, in accordance with one embodiment.

### DETAILED DESCRIPTION

Overview

The following description relates to techniques for enabling a user to compose and send a broadcast fax such as from a computer-based fax solution. The broadcast fax techniques can contribute to creating a user-friendly computer-based fax experience.

A broadcast fax is a fax message that is sent to multiple recipients, or to a fax group consisting of many individual recipients. At least some of the present embodiments customize the fax message for individual fax recipients. For instance, a user can designate a plurality of fax recipients to receive fax content. A plurality of customized faxes is created for the fax recipients. For instance, some implementations create a customized coversheet or cover page for each fax recipient. The customized cover sheet is combined with the fax content and sent to a specific fax recipient. The process, in turn, is sequentially repeated for each designated fax recipient. In at least some implementations, creation and sending of the customized faxes is handled automatically and does not require further action on the part of the user. Rather, the user may merely select the fax recipients; create the fax content and issue a send command such as by clicking a send button. The user can rely on the underlying system components to handle the rest.

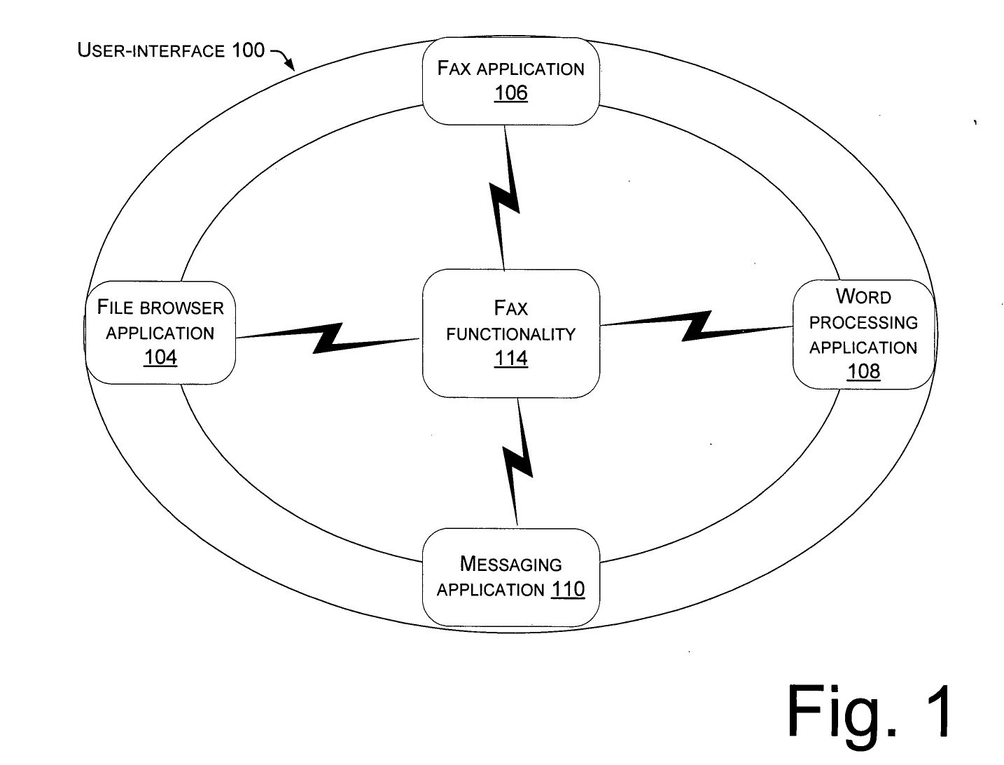

Consider FIG. 1 as an example of a PC user-interface 100 for creating a user's fax experience. Non-limiting examples of applications that can be exposed on user-interface 100 include a file browser application 104, a fax application 106, a word processing application 108, and a messaging application 110. Centrally positioned for purposes of explanation is an integrated fax functionality 114. The fax functionality is achieved, at least in part, by the fax application 106. For instance, the fax functionality may be achieved by the fax application, in combination with other portions of the user-interface, such as various other applications. Stated another way, the fax functionality may be exposed to a user as a fax client portion of the user-interface.

A user interacting with user-interface 100 and desiring to utilize the fax functionality 114 can access the fax functionality from a number of applications and/or aspects of the user-interface which are convenient for the user. For instance, assume that the user is working in word processing application 108 and composes a document. The user then decides that he or she wants to fax the document to a fax recipient for review. The user can utilize an access point in the word processing application to access the fax functionality 114. In another example, a user may utilize file browser application 104 to locate a particular file. Upon locating the file, the user may desire to fax the file to one or more fax recipients. An access point located in the file browser allows the user to access the fax functionality for faxing the file. In another instance, the user may access the fax functionality from an aspect of the user-interface which is not directly related to a specific application. For example, an access point may exist on a portion of the user-interface created by the operating system. For example, the operating system may allow a user to control a peripheral device coupled to the operating system and may provide an access point to the fax functionality in concert with the user controls for the peripheral device.

Further, in some implementations, the user-interface related to the fax functionality can be consistent with other portions of the user-interface which are available to the user on user-interface 100. For instance, the user-interface may allow the user to launch the fax functionality in the same, or a very similar manner, as is utilized to launch an email functionality. In some implementations the fax functionality may be integrated with another functionality to provide a unified portion of the user-interface. For instance, the fax functionality and the email functionality may be integrated to create an integrated or unified portion of the user-interface relating to communicating information with others whether the communication is via email, fax, or both. For instance, the fax client portion of the user interface may be unified with or have a similar ‘look and feel’ as the email client. Configurations which provide a fax user-interface which is consistent with, and/or integrated with, other portions of the user-interface can be more intuitive to the user and can contribute to improved user satisfaction of both the fax experience and the overall user-interface experience.

Cumulatively, the user-interface configuration described in relation to FIG. 1 allows a user to compose and send a fax in the manner that makes sense to the particular user at any given time. What feels most natural for a particular fax scenario today, may not feel like the best or most effective way for another fax scenario tomorrow. The nature of the content might influence the creation path selected by the user and this implementation allows the user the flexibility to select the path as he or she so desires.

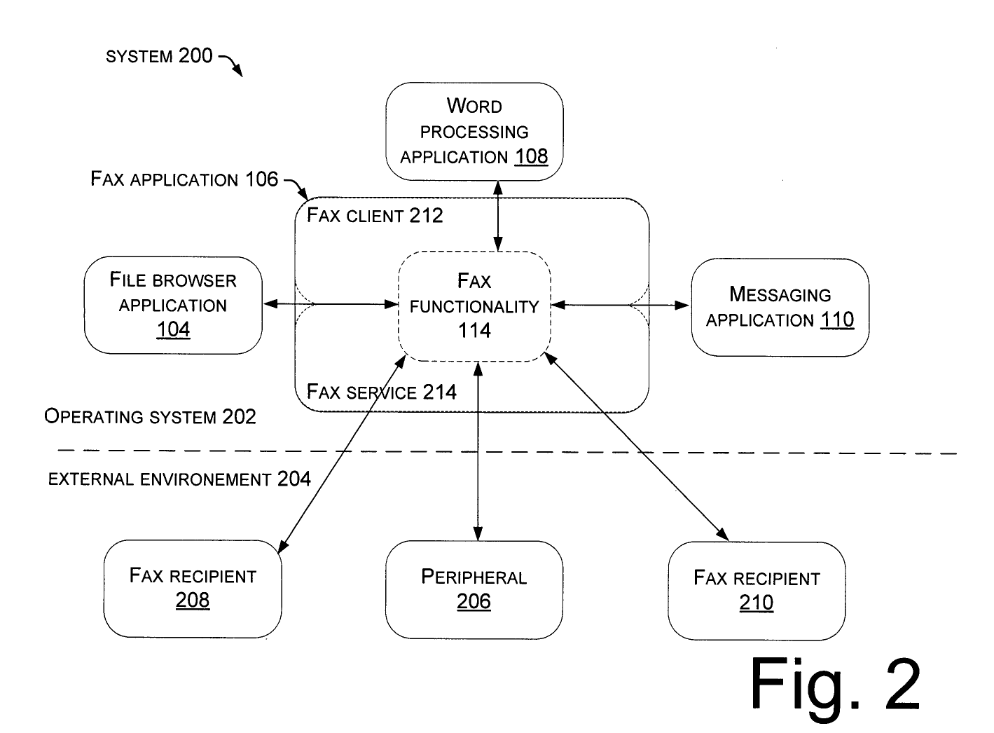

FIG. 2 illustrates an example of a system 200 consistent with providing a flexible and integrated fax functionality to the user-interface. System 200 includes, by means of non-limiting example, file browser application 104, fax application 106, word processing application 108, and messaging application 110 operating in cooperation with an operating system 202. System 200 also includes in an external environment 204, and by means of non-limiting example, a peripheral device 206, and fax recipients 208, 210 communicating with the fax functionality 114 via the operating system 202. In this particular configuration, fax application 106 includes a fax client component 212 and a fax service component 214. In a general sense the fax client 212 relates to the user-interface portions of the fax functionality or how the user interacts with the fax functionality. The fax service component generally relates to the underlying core infrastructure or developer platform of the fax functionality. The fax client component and the fax service component are described in more detail below.

The implementations described above and below are described in the context of a computing environment as commonly encountered at the present point in time. Various examples can be implemented by computer-executable instructions or code means, such as program modules, that are executed by a computer, such as a personal computer (PC). Generally, program modules include routines, programs, objects, components, data structures and the like that perform particular tasks or implement particular abstract data types.

Various examples may be implemented in computer system configurations other than a PC. For example, various embodiments may be realized in Apple Macintosh computers, tablet PCs, hand-held devices, multi-processor systems, microprocessor-based or programmable consumer electronics, network PCs, minicomputers, mainframe computers, cell phones, and the like. Further, as technology continues to evolve, various implementations may be realized on yet to be identified classes of devices.

Various examples may be practiced in distributed computing environments, where tasks are performed by remote processing devices that are linked through a communications network. In a distributed computing environment, program modules may be located in both local and remote memory storage devices.

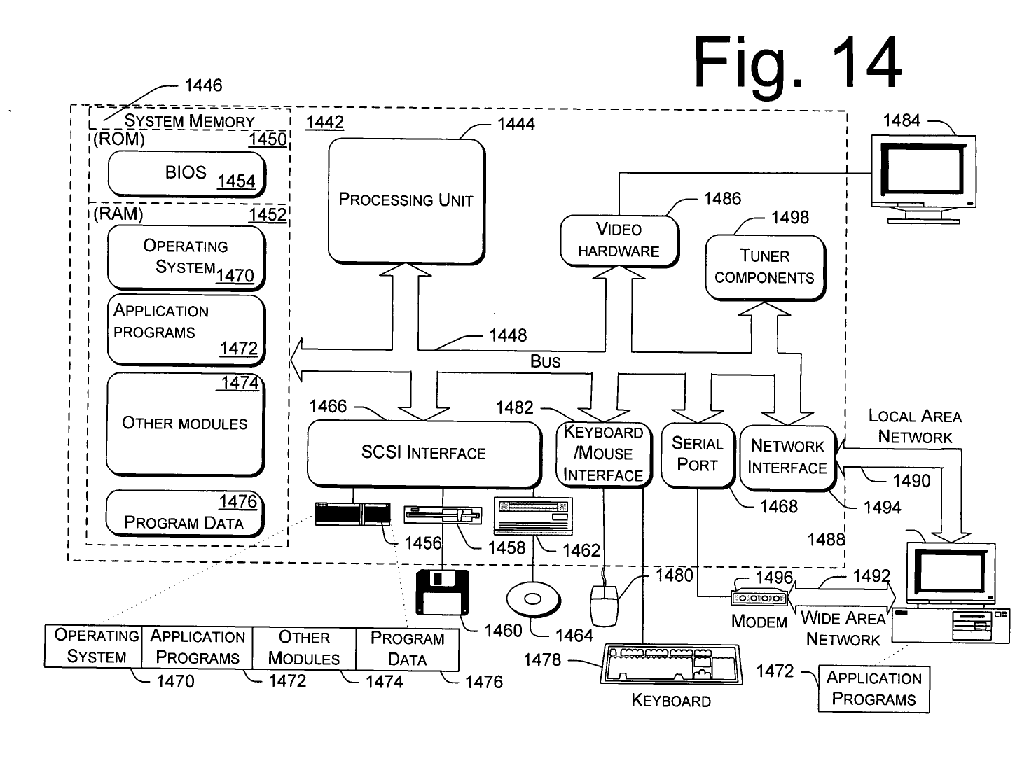

Although the various implementations may be incorporated into many types of operating environments as suggested above, a description of but one exemplary environment appears in FIG. 14 in the context of an exemplary general-purpose computing device and which is described in more detail later in this document under the heading “Exemplary Operating Environment”.

For purposes of explanation and by way of example, more detailed descriptions of various components and functionalities are described below in relation to the Windows® operating system offered by Microsoft® Corporation and also in relation to various applications, such as Word® brand word-processing application and Outlook® brand messaging application, offered by Microsoft Corporation. The Windows operating system and associated applications are widely recognized and as such provide a suitable platform for explanation. The skilled artisan should recognize other suitable operating systems and/or applications consistent with the discussion provided above and below.

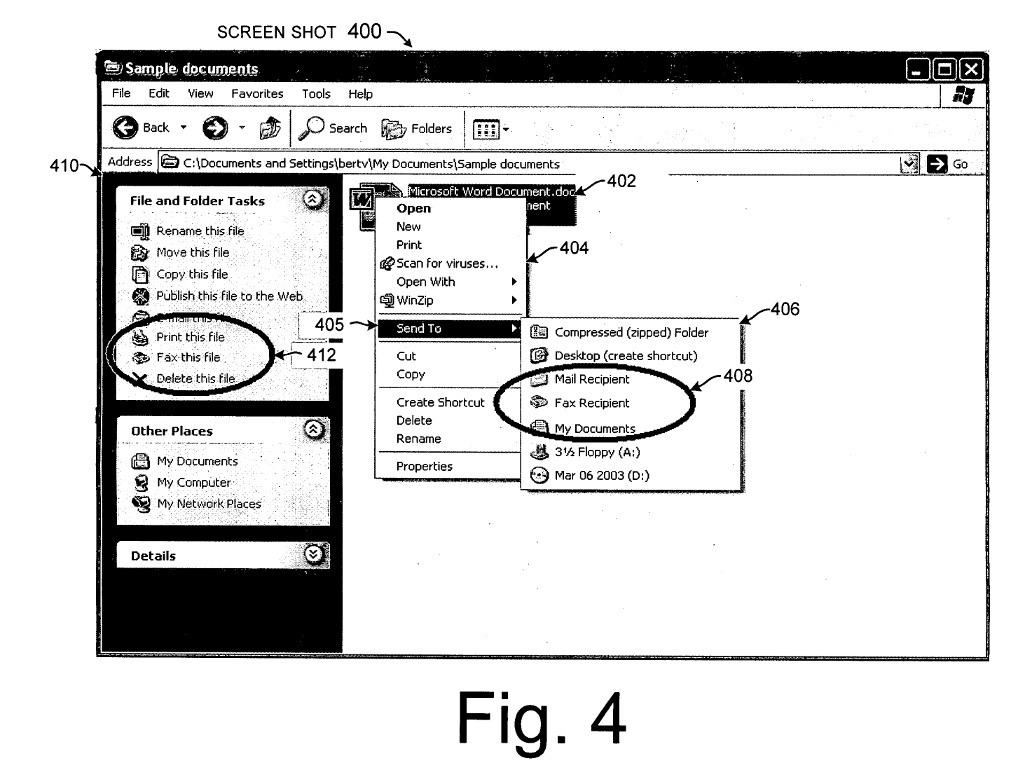

Previous fax solutions, whether hardware-based or software-based, create a fax composition scenario which is serial from beginning to end. In contrast, consider the examples described in relation to FIGS. 4-8 of a user interface providing multiple paths for a user to access a fax functionality and compose a fax. For instance, in addition to the user accessing the fax functionality by accessing a fax application, the user may access the fax functionality through an application and/or portion of the user-interface which is primarily not a fax application or fax-centric functionality. Further, with previous solutions, if a user desired to send a fax to multiple users, the user either had to send a generic fax, or tediously create a separate individualized fax for each of the multiple fax recipients. Neither of the options led to a satisfactory user experience. Alternatively or additionally, the implementations described below are easier for the user to learn and use than existing fax solutions and underlying processes can be transparent to the user.

Exemplary Embodiments

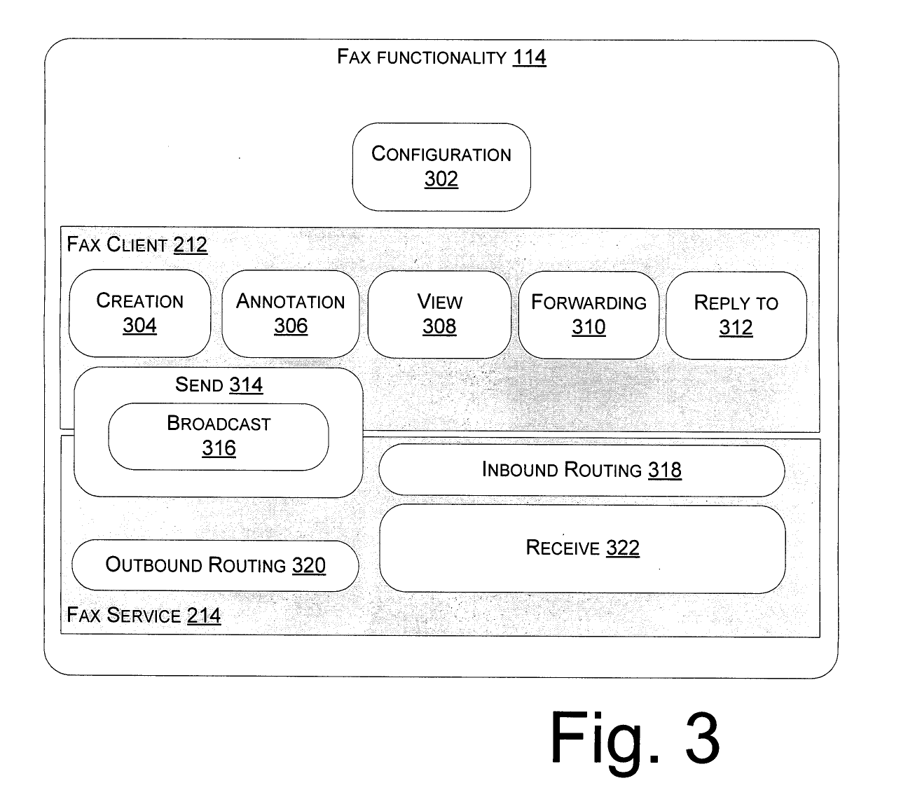

FIG. 3 illustrates a more detailed view of fax functionality 114. The fax functionality includes various functionalities, some of which are represented here as functional blocks. Fax functionality 114 includes a configuration functionality 302, fax client component 212, and fax service component 214. The fax configuration functionality serves to set up individual user fax accounts and configures the fax client and fax service components accordingly.

The fax client 212 generally relates to user-interface portions of the fax functionality. A creation functionality 304, an annotation functionality 306, a view functionality 308, a forwarding functionality 310, and a reply to functionality 312 are accomplished by the fax client. The creation functionality allows the user to create or compose a fax. Similarly, the fax can be annotated, viewed, forwarded and/or replied to by the user. Various fax functionalities will be described in more detail below by way of example.

A send functionality 314 and a sub-set thereof, designated as the broadcast functionality 316, are accomplished by acts carried-out by both of the fax client 212 and the fax service 214. The send functionality 314 allows the user to send the fax to a fax recipient. The broadcast functionality 316 allows the user to send the fax to a plurality of fax recipients such that each fax recipient receives a customized version in at least some implementations. In this particular configuration, a portion of the send functionality is accomplished by the fax client 212 and a portion of the send functionality is accomplished by the fax service 214. For instance, the fax client prepares the fax for sending, such as by determining the fax recipients, while the fax service executes sending the fax, such as by sending individual faxes to individual fax recipients.

The fax service 214 accomplishes queuing of faxes and sending them out to a faxing mechanism. As such, an inbound routing functionality 318, an outbound routing functionality 320, and a receive functionality 322 are accomplished by the fax service sub-component 214. In at least some instances, the fax routing functionality is implemented as an API which provides software vendors with a flexible way to connect software applications that route received fax transmissions through multiple routing methods. These routing methods can include, but are not limited to, printing faxes, storing faxes, converting fax graphic images to text files, and delivering faxes in electronic mail attachments. Accessing a Fax Functionality from a File Browser

FIG. 4 illustrates a screenshot 400 encountered utilizing a file browser application such as a Windows® Explorer® brand file browser application. In this instance, the user utilizes the browser application to locate a file that the user wishes to fax. Once the file is located, the file browser application offers the user several access points to the fax functionality. As a first option, the user can right click on the file's icon 402. Responsive to the user right clicking on the icon, a context menu 404 is generated. The user can select a ‘Send to’ command 405 which causes a second context menu 406 to be generated. From the second context menu the user can select ‘Fax recipient’ as indicated at 408. Alternatively, the user can select from the ‘File and Folder Tasks' 410 or a ‘Fax this File’ command at 412. Responsive to the user command, the fax application is launched. The fax application then generates a fax composition window, examples of which are described in more detail below. Access a Fax Functionality from a Communication Application

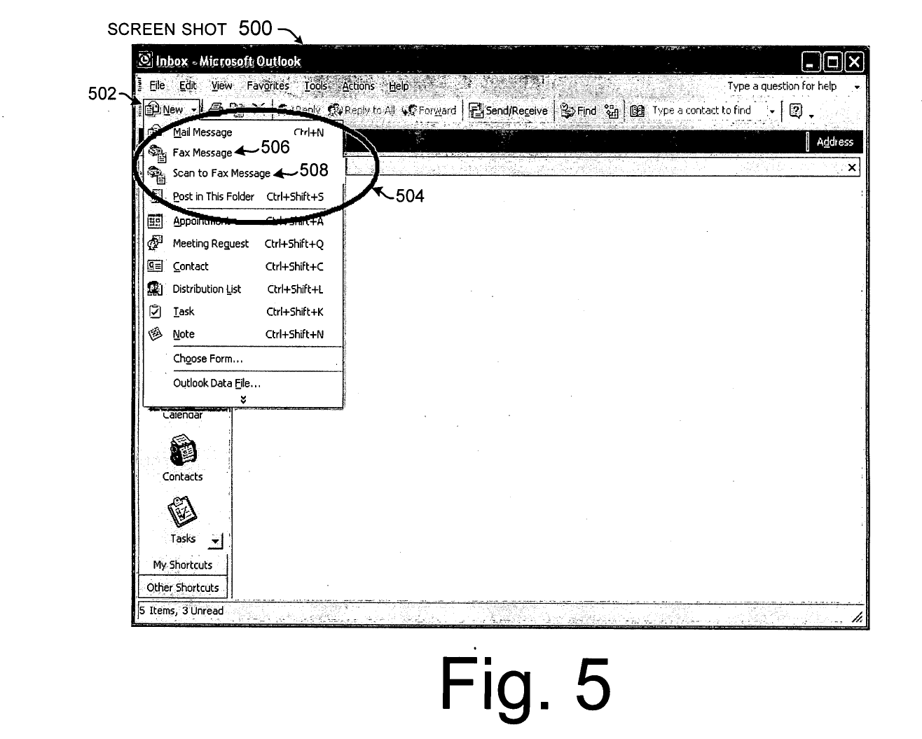

FIG. 5 illustrates a screenshot 500 encountered utilizing an email application such as Windows® Outlook® brand email/messaging application. In this particular implementation the fax functionality and email functionality are unified as an overall unified messaging application. In this instance, a user can access the fax functionality through the unified Outlook-brand messaging application in several ways. For instance, the user may click on the ‘New’ heading/icon indicated at 502. One or more fax options indicated generally at 504 may appear on the list of options provided to the user. In this particular instance, the user may choose from a ‘Fax Message’ 506 or a ‘Scan to Fax’ 508 option. Either of these options can allow the user to access the fax functionality through which a fax composition window is generated.

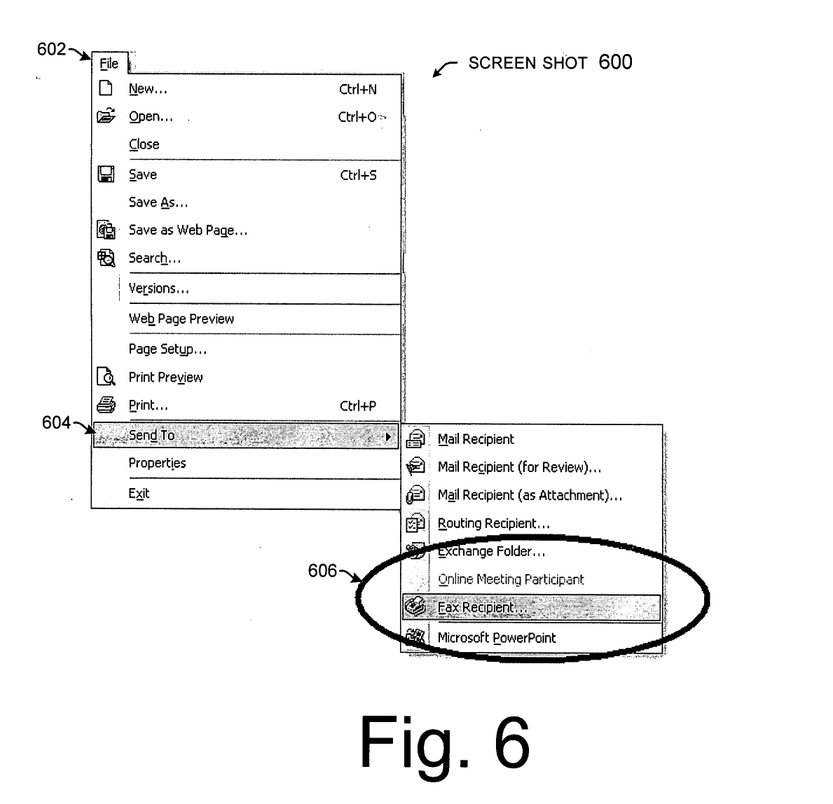

FIG. 6 illustrates another example of an access point to the fax functionality through the unified Outlook-brand message application. In this instance, screenshot 600 allows the user to click on the ‘File’ heading/icon 602. A ‘Send To’ option indicated at 604 is one of the options provided within the ‘File’ heading/icon. One of the possible destinations of the ‘Send To’ option is ‘Fax Recipient’ 606. Though FIG. 6 is described in relation to a messaging application, such fax access points could be enabled from many generic applications which are not primarily message or fax related.

Accessing a Fax Functionality Via a Fax Application

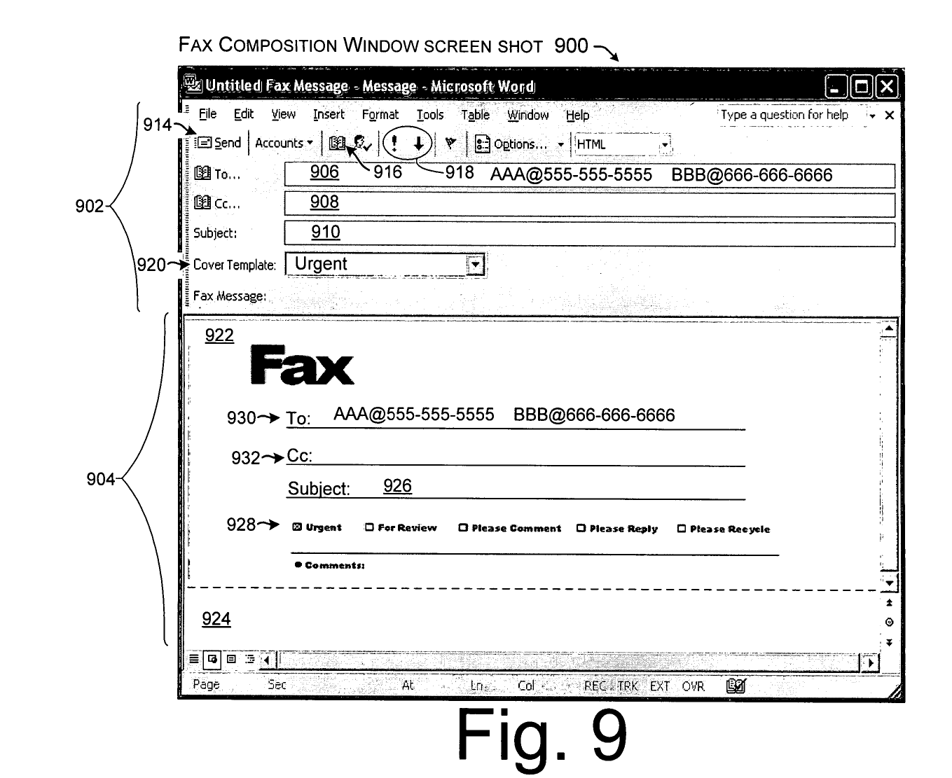

In some implementations, the fax application may be a fax-dedicated application which the user can access in any of a multitude of known ways. Alternatively or additionally, the fax application may be integrated with other applications to create a more unified user-interface. In either instance where the user prefers to access the fax functionality more directly, the user may simply open the fax application. Within the fax application, the user may proceed along various paths. For instance, the user may select ‘New fax’. Responsive to the user command, the fax application generates a fax composition window, examples of which are described below in relation to FIGS. 9, 11 and 13.

Create a Fax from an Existing Paper Document

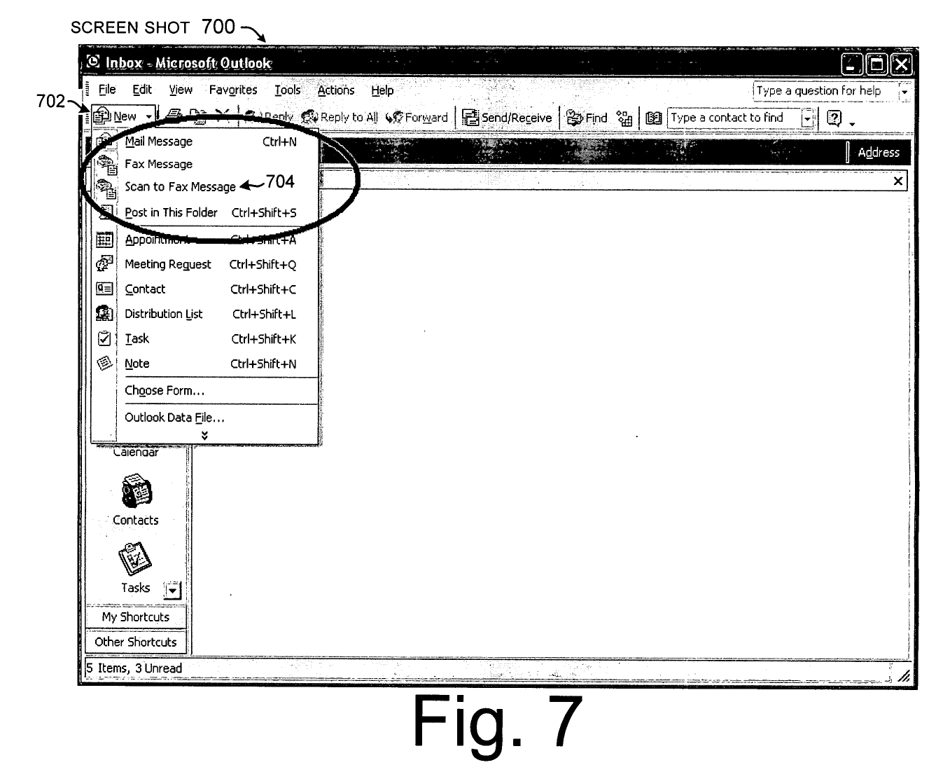

If the user wants to send an existing paper document via fax he/she can follow the path that seems most straightforward. For instance, the user can open the fax application, and with a single click, scan to the fax application. For example, FIG. 7 shows a screenshot 700 of such a configuration where the fax functionality is integrated with the email functionality as a unified Windows Outlook-brand messaging or communication application. In this instance the user can click on the ‘New’ heading/icon 702 and scroll down to ‘Scan to Fax Message’ 704 to import directly from the scanner to the fax application. In at least some applications, in relation to a scanner or multi-function peripheral (MFP) a driver will cause the scan to start automatically and scan any paper document on the scanner or MFP without further user intervention. In instances where the scanner does not have a document feeder, the user subsequently may be asked if the user wants to scan another page. Also, in scenarios where more than one scanner is attached to the PC the user will be asked which device to use or scan from.

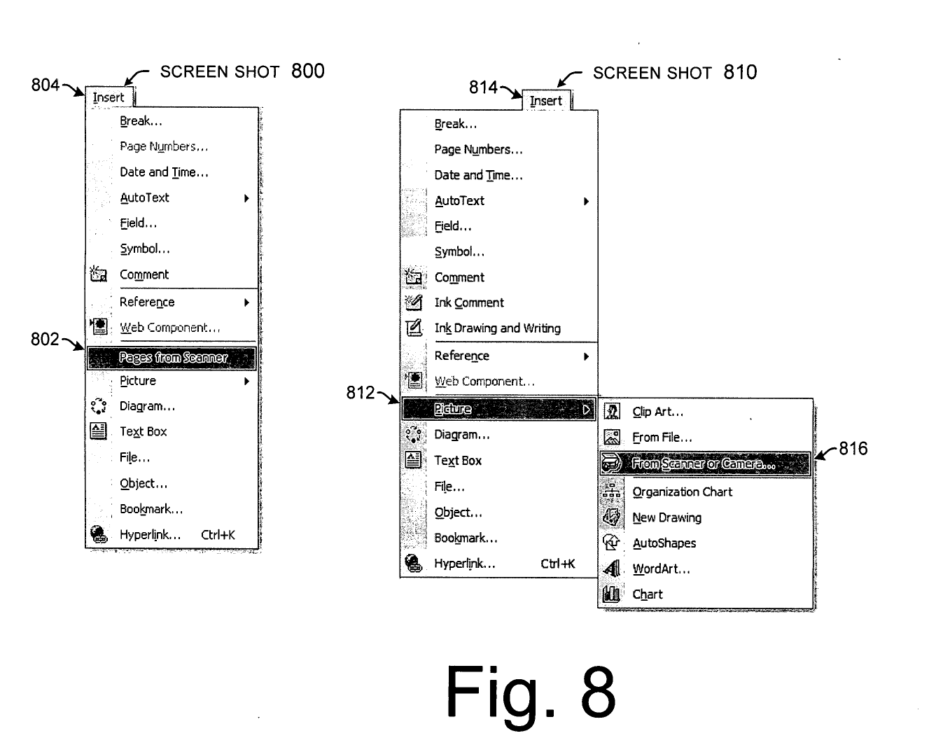

FIG. 8 illustrates two alternative configurations for transferring content from a scanner to a fax application and inserting the content into a fax message that is being composed. As shown in screenshot 800, the user can open the fax application, and select ‘Pages from Scanner’ 802 under the ‘Insert’ menu 804 and insert scanned pages directly into the body of the compose window. This scan does not require any further user intervention in a scenario where the desired pages are already positioned on the scanner. Once the pages are scanned into the fax application's composition window, the user can edit between the scanned pages and/or move the scanned pages as described above and below.

Still a further option which is shown in screenshot 810 is for the user to open the fax application, and select ‘Picture’ 812 under the ‘Insert’ heading/icon 814. The user can then select ‘From Scanner or camera’ 816 to insert a scanned area of a single page directly into the body of the fax compose window. In some such instances, the user can utilize software associated with the scanner that allows the user to crop the image and manipulate other scanning parameters as desired.

The examples provided above are not intended to be limiting in any manner. To the contrary, these examples should aid the skilled artisan in applying the concepts described above and below to new system configurations as they become available so that a user-interface can be configured which collectively provides increased fax flexibility to the user.

Composing and Sending a Broadcast Fax

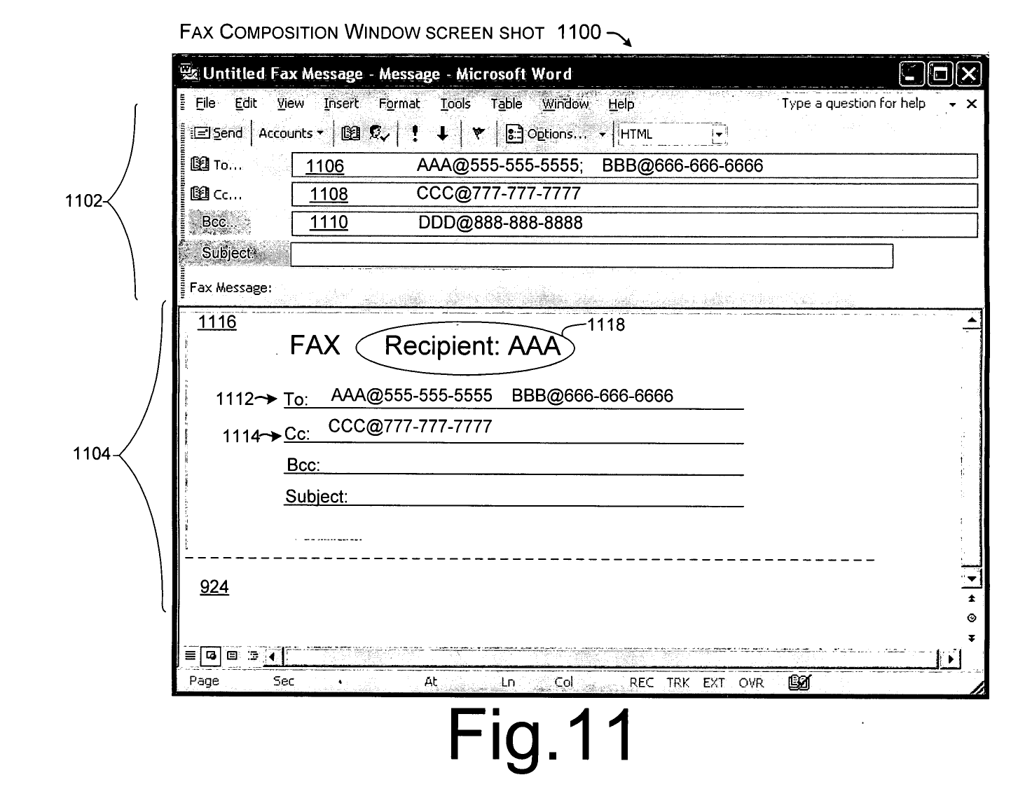

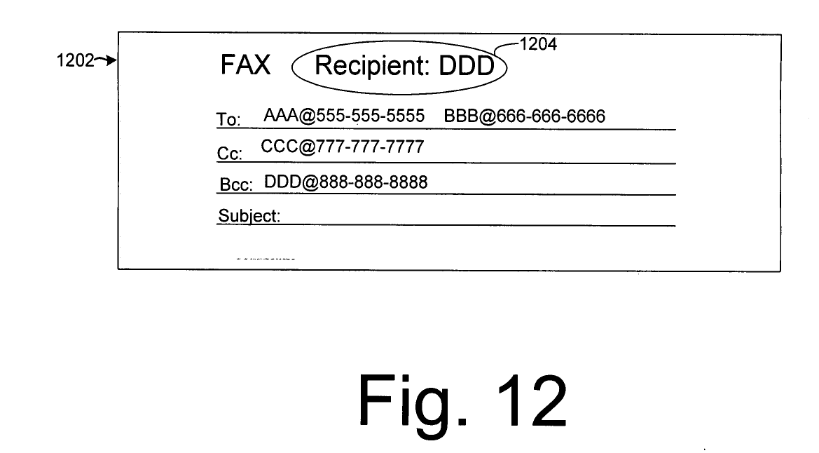

FIG. 9 illustrates a screenshot of one implementation of a fax composition window 900, which in this particular configuration, includes a header 902 and a compose field 904. The header 902 can include various fields and allow various user commands, only some of which are mentioned here with specificity. In the particular configuration illustrated in FIG. 9, the header has a ‘To’ field 906, a ‘Cc’ field 908, and a ‘Subject’ field 910. Some implementations also support blind courtesy copy (Bcc) fields and associated functionality. An example of such an implementation is described below in relation to FIGS. 11-12. The presently described configuration also includes various command tools including ‘Send’ 914, an address book/contacts 916, fax priority designators 918, and a coversheet template dropdown selection menu 920, among others. The coversheet template dropdown selection menu 920 allows the user to specify special designators on the coversheet such as, for example, ‘urgent’, ‘for review’, ‘please comment’, ‘please reply’, and ‘confidential’ among others.

The address book 916 can be shared with an email client or can be a dedicated address book for a fax client. A shared or unified email and fax address book can be configured, in some implementations to contain at least one email address for an email recipient and at least one fax number for a fax recipient.

Fax recipients can be entered into the ‘To’ and ‘Cc’ fields 906, 908, of the header by any combination of selecting from the address book 916 and/or manually typing, among others. In this implementation when the user selects an individual fax recipient from the contacts or address book, the fax recipient appears in the appropriate ‘To’ or ‘Cc’ field as “recipient name@fax number”. The ‘name@fax number’ configuration is consistent with the familiar format of many email applications which utilize a “recipient name@address” format. Such a configuration also facilitates enabling a search tool for sent and/or received faxes, but is only one of many possible configurations. In instances where the user utilizes a group alias, the fax application resolves the recipient names and addresses when the user sends the fax.

A coversheet 922 is automatically populated at the top or beginning of the compose field 904. The user can add content below the coversheet as indicated generally at 924. The coversheet is automatically populated with data from header 902 where applicable. For instance, data from subject field 910 is automatically populated into the coversheet's ‘Subject’ field 926 and the user's selection of a coversheet template from the coversheet template dropdown selection 920 is automatically populated into the template selection boxes indicated generally at 928. In this instance, an ‘Urgent’ box is checked corresponding to the coversheet template designation in the header 902.

In at least some of the present implementations, the coversheet's ‘To’ field 930 and ‘Cc’ field 932 are also automatically populated from the header. For instance, the designated fax recipients of ‘To’ field 906 are populated to the coversheet's ‘To’ field 930. Similarly, designated ‘Cc’ recipients from the header's ‘Cc’ field are populated into the coversheet's ‘Cc’ field 932. At least some of these implementations customize the coversheet for individual fax recipients. For instance, in this particular broadcast fax configuration, the coversheet 922 that appears in the compose window 904 lists the fax recipients in the order in which they appear in the ‘To field’ 906 of the header 902. In this particular example, the first recipient in ‘To field’ 906 is a hypothetical fax recipient AAA@555-555-5555 which is also the first fax recipient listed in the coversheet's ‘To field’ 930.

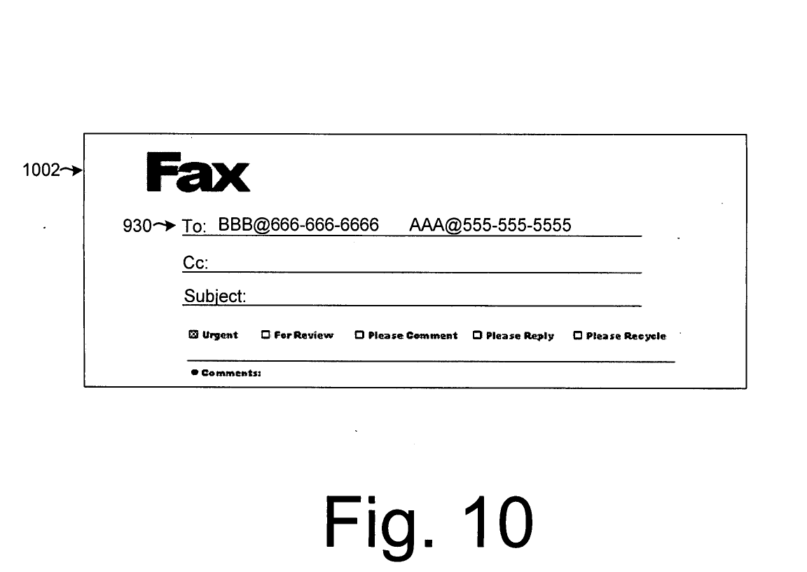

In this implementation, the coversheet illustrated in FIG. 9 is the only coversheet presented to the user in the composition window 900. However, and as can be appreciated from considering FIG. 9 collectively with FIG. 10 a customized coversheet is generated for individual fax recipients and combined with the content 924 as a customized fax which is sent to a specific fax recipient.

FIG. 10 illustrates a second coversheet 1002 generated for hypothetical fax recipient BBB@666-666-6666. This coversheet reorders the fax recipients in the ‘To’ field 930 so that the actual fax recipient that this coversheet will be faxed to is listed first on the coversheet. In this particular configuration, all of the recipients are still listed on the coversheet so that the recipient who receives this fax knows the other fax recipients. However, customizing the coversheet so that the intended recipient is listed first increases the chances of the fax recipient actually receiving the fax. For ease of explanation, there are only two fax recipients designated in FIGS. 9-10, but consider the following scenario.

Assume that a broadcast fax is sent to ten fax recipients with the same coversheet utilized for each fax recipient. Further assume that the fax number for the 10^{th} listed recipient goes to a fax machine in a busy corporate copy room. The person who first sees the fax on the fax machine is unlikely to be the actual recipient, and if that person looks at the fax and does not recognize one of the first few names on the fax he/she may not look any further assuming that the fax was erroneously received. As a result, the fax may get thrown away or get put into an ‘unclaimed bin’ or something similar. In contrast, if the person who looks at the fax recognizes the first name on the fax, then the fax is much more likely to get directed to the intended fax recipient. Thus, by customizing the broadcast fax coversheet for individual fax recipients, the likelihood that the fax will actually be received by the intended recipient is increased.

In a broadcast fax scenario, at least some of the described embodiments utilize data from the header 902 in combination with the added content 924 of the body 904 to create a customized fax for individual fax recipients. Individual faxes are then sent to the corresponding fax number of the corresponding recipient. Some implementations may create all of the customized faxes for a particular broadcast fax composition and then sequentially send the customized faxes as fax mechanisms are available. Other implementations first may send the fax represented in the composition window to the appropriate fax recipient. A customized fax for the next listed fax recipient is then dynamically generated and sent. The process is then repeated until a customized fax has been sent to each fax recipient. Some of these implementations may save processing and/or memory resources by dynamically re-rendering only those pages of the faxes which are customized and reusing any material which is consistent among the faxes. For instance, in the above described scenario only the coversheet is re-rendered between individual faxes. In at least some implementations, the fax service component described above in relation to FIG. 3 handles customizing and sending the individual faxes without further attention by the user.

FIG. 11 illustrates another configuration for customized broadcast faxes. FIG. 11 shows a fax composition window screenshot 1100 having header 1102 and body 1104. In this configuration, header 1102 has three types of fields for fax recipients. A ‘To’ field 1106, a ‘Cc’ field 1108, and a ‘Bcc’ field’ 1110. For purposes of explanation the ‘To’ field 1106 is populated with two hypothetical fax recipients AAA@555-555-5555 and BBB@666-666-6666. Further, the ‘Cc’ field 1108 is populated with a hypothetical fax recipient CCC@777-777-7777 and the ‘Bcc’ field 1110 is populated with hypothetical fax recipient DDD@888-888-8888.

The fax recipients from the ‘To’ field 1106 and the ‘Cc’ field 1108 are populated into the corresponding ‘To’ field 1112 and ‘Cc’ field 1114 of coversheet 1116. The coversheet illustrated in fax composition window 1100 is customized for hypothetical recipient AAA@555-555-5555. The name portion “AAA” of fax recipient AAA@555-555-5555 has been automatically populated to a ‘Recipient’ field 1118 at the top of the coversheet which can aid in AAA actually receiving the fax. Further, the coversheet shows the fax recipients, with the exception of the ‘Bcc’ field recipient (otherwise it wouldn't be a blind copy), in the order and position in which the recipients are listed in the header. In this configuration, showing a ‘Bcc’ field on the coversheet without showing the ‘Bcc’ recipient lets recipient AAA know that such a feature exists relative to this broadcast fax. Other configurations may eliminate the Bcc field altogether on the coversheets customized for the To field and Cc field fax recipients so that those recipients are not aware that such a feature may be utilized. Customized faxes similar to that of FIG. 11 can be generated for the remaining ‘To’ field and ‘Cc’ field fax recipients.

FIG. 12 shows a customized coversheet 1202 generated for Bcc field fax recipient DDD@888-888-8888. The hypothetical name DDD is shown in ‘Recipient field’ 1204 and all of the fax recipients appear on this customized coversheet as they do on the header 1102 (indicated FIG. 11).

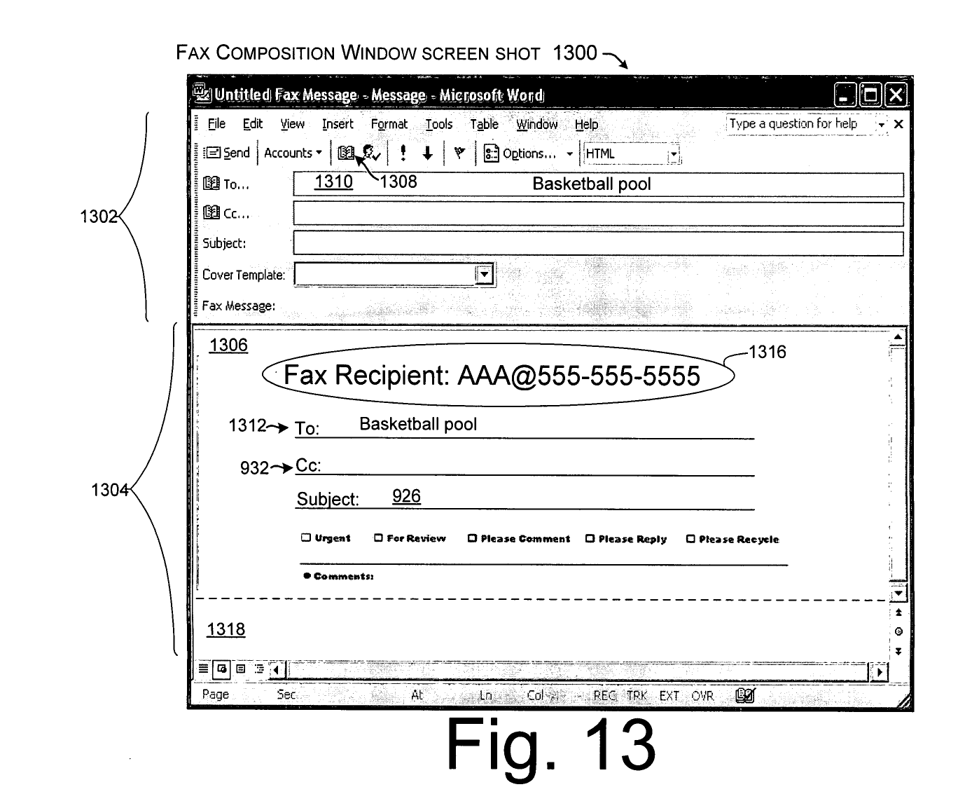

FIG. 13 illustrates a fax composition window screenshot 1300 of still another configuration for customized faxes. This fax composition window includes a header 1302 and a compose field 1304 containing a coversheet 1306. Assume for purposes of explanation that in this instance, the user has selected a group alias called “basketball pool” from the header's address book 1308. A group alias can be created by the user for any desired group of fax recipients. So, in this instance, assume that the user previously established the ‘basketball pool’ group alias for all the people entered in his of her basketball pool. The user can select the group alias and appropriate fields are populated in both the header and body of the fax with all the group alias members.

In this instance, the basketball pool group alias is automatically populated into both the ‘To’ field 1310 of the header and the ‘To’ field 1312 of the coversheet 1306. Also, in this configuration the group alias appears in the ‘To’ fields rather than all of the individual recipients of the group alias. This feature can be more convenient for the user in that a single selection can designate multiple fax recipients, and also reduces the number of recipient names and fax numbers which might otherwise fill the available space in the ‘To’ field (or the ‘Cc’ field). Other implementations may list all the group members in the appropriate fields. In this instance, the group alias name appears in the ‘To’ fields 1310, 1312 while an individual Fax Recipient from the group alias is indicated on the coversheet. In this instance, the first intended fax recipient of the basketball pool group alias is hypothetical group member AAA@555-555-5555 as indicated generally at 1316. In the illustrated configuration, the entire name at fax number is listed as the fax recipient. Other implementations may list a sub-portion or other moniker as the fax recipient. For instance, in this example the fax recipient may be listed simply as “AAA”. In at least some configurations which utilize a fax recipient or similar designation, the entries in the ‘To’, ‘Cc’ and/or ‘Bcc’ fields constitute a distribution list from which customized faxes can be created for individual fax recipients of the distribution list.

While only a single coversheet is illustrated in FIG. 13, the broadcast fax functionality can generate a customized coversheet consistent with the illustrated configuration for each member of the distribution list with their respective name populating the Fax Recipient field. In at least some implementations, individual customized coversheets are combined with content 1318 to create customized faxes for individual fax recipients without any further action on the part of the user.

Fax Status

Once the user sends a fax, such as by clicking a send command, at least some embodiments can provide a means for monitoring the status of the fax. For instance, with the Outlook brand messaging application, an identifier of the fax may appear in an outbox until the fax is successfully sent, at which time the identifier is moved to a sent items folder. In a broadcast fax scenario, since a customized fax is sent to individual designated fax recipients, a separate identifier may appear for each fax recipient. As such, at a given point in time, when some of the customized faxes of a broadcast fax have been successfully sent, some of the customized faxes may appear in the sent items while others remain in the outbox.

At least some implementations group the customized faxes associated with a user's send command. For instance, where a group alias is utilized, individual faxes may be listed in the outbox and/or sent items listed under the group alias. Such a configuration allows the user to quickly determine the status of faxes for individual fax recipients within the group alias. In such a configuration the group alias may be listed in the outbox with some of the individual faxes which are still pending and also be listed in the sent items with individual faxes which have been sent. In instances where multiple fax recipients are designated without a group alias, some type of reference header can be generated to aid the user in recognizing which pending and sent faxes are associated with the user's particular ‘send’ command. For instance, in some implementations, the user-interface generates a hierarchical tree view which the user can ascend or descend to garner a desired level of detail regarding a broadcast fax generally or individual faxes of the broadcast fax. For example, the header related to the broadcast fax may contain the subject and the date and time stamp of when the broadcast fax was initiated. Correspondingly, the individual faxes listed under the header each have their own time and date stamp. Further, in a broadcast fax scenario, the user may receive a confirmation or delivery receipt for each of the individual customized faxes. Similarly, if a broadcast fax is unsuccessful to an individual fax recipient of the plurality of fax recipients, the fax can be resent to that individual fax recipient rather than to all of the designated fax recipients.

In the illustrated and described embodiments a broadcast fax functionality is provided for the user. At least some embodiments generate customized faxes for individual recipients of a broadcast fax. Further examples regarding fax set-up and various fax options such as viewing, forwarding and replying to faxes are described in U.S. patent application Ser. No. ______, entitled “Techniques for Creating a User-friendly Computer-Based Fax Experience”, naming as inventor Hubert Van Hoof, filed on _, assigned to the assignee of this document, and bearing attorney docket number ms1-2425us.

Exemplary Operating Environment

FIG. 14 shows an exemplary computing device that can be used to implement broadcast faxing as described above. Computing device 1442 comprises one or more processors or processing units 1444, a system memory 1446, and a bus 1448 that couples various system components including the system memory 1446 to processors 1444. Threading techniques can be employed on the one or more processors to allow parallel processing of multiple tasks by multiple processing threads.

The bus 1448 represents one or more of any of several types of bus structures, including a memory bus or memory controller, a peripheral bus, an accelerated graphics port, and a processor or local bus using any of a variety of bus architectures. The system memory 1446 comprises read only memory (ROM) 1450 and random access memory (RAM) 1452. A basic input/output system (BIOS) 1454, containing the basic routines that help to transfer information between elements within computing device 1442, such as during start-up, is stored in ROM 1450.

Computing device 1442 can further comprise a hard disk drive 1456 for reading from and writing to a hard disk (not shown), a magnetic disk drive 1458 for reading from and writing to a removable magnetic disk 1460, and an optical disk drive 1462 for reading from or writing to a removable optical disk 1464 such as a CD ROM or other optical media. The hard disk drive 1456, magnetic disk drive 1458, and optical disk drive 1462 are connected to the bus 1448 by an SCSI interface 1466 or some other appropriate interface. The drives and their associated computer-readable media provide nonvolatile storage of computer-readable instructions, data structures, program modules, and other data for computer 1442. Although the exemplary environment described herein employs a hard disk, a removable magnetic disk 1460 and a removable optical disk 1464, it should be appreciated by those skilled in the art that other types of computer-readable media which can store data that is accessible by a computer, such as magnetic cassettes, flash memory cards, digital video disks, random access memories (RAMs), read only memories (ROMs), and the like, may also be used in the exemplary operating environment.

A number of program modules may be stored on the hard disk 1456, magnetic disk 1460, optical disk 1464, ROM 1450, or RAM 1452, including an operating system 1470, one or more application programs 1472 (such as a user agent or browser), other program modules 1474, and program data 1476. A user may enter commands and information into computer 1442 through input devices such as a keyboard 1478 and a pointing device 1480. Other input devices (not shown) may comprise a microphone, joystick, game pad, satellite dish, scanner, or the like. These and other input devices are connected to the processing unit 1444 through an interface 1482 that is coupled to the bus 1448. A monitor 1484 or other type of display device is also connected to the bus 1448 via an interface, such as video hardware 1486. In addition to the monitor, personal computers typically comprise other peripheral output devices (not shown) such as speakers and printers.

Computer 1442 commonly operates in a networked environment using logical connections to one or more remote computers, such as a remote computer 1488. The remote computer 1488 may be another personal computer, a server, a router, a network PC, a peer device or other common network node, and typically comprises many or all of the elements described above relative to computer 1442. The logical connections depicted in FIG. 14 comprise a local area network (LAN) 1490 and a wide area network (WAN) 1492. Such networking environments are commonplace in offices, enterprise-wide computer networks, intranets, and the Internet.

When used in a LAN networking environment, computer 1442 is connected to the local network through a network interface or adapter 1494. When used in a WAN networking environment, computer 1442 typically comprises a modem 1496 or other means for establishing communications over the wide area network 1492, such as the Internet. The modem 1496, which may be internal or external, is connected to the bus 1448 via a serial port interface 1468. In a networked environment, program modules depicted relative to the personal computer 1442, or portions thereof, may be stored in the remote memory storage device. It will be appreciated that the network connections shown are exemplary and other means of establishing a communications link between the computers may be used.

The computer could also contain analog or digital tuner components 1498. The tuner components can be linked to the system either through an internal or extended bus such as PCI or external bus such as USB bus, IEEE-1494 bus. The tuner components allow the system to receive broadcasting TV through standard TV broadcasting media such as terrestrial, cable, and satellite.

Generally, the data processors of computer 1442 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The system described herein comprises these and other various types of computer-readable storage media when such media contain instructions or programs for implementing the blocks described, in conjunction with a microprocessor or other data processor. The system described can also comprise the computer itself when programmed according to the methods and techniques described herein.

For purposes of illustration, programs and other executable program components such as the operating system are illustrated herein as discrete blocks, although it is recognized that such programs and components reside at various times in different storage components of the computer, and are executed by the data processor(s) of the computer.

Exemplary Processes

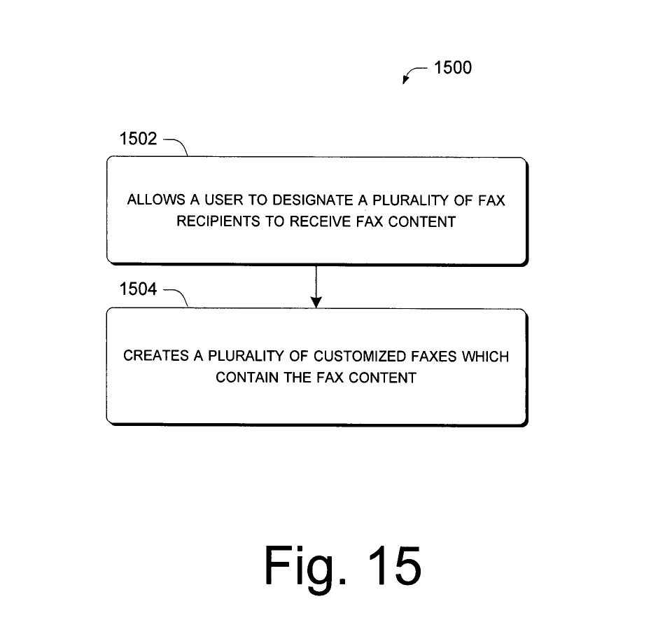

FIG. 15 represents a process for enabling broadcast faxing in accordance with one embodiment.

Block 1502 allows a user to designate a plurality of fax recipients to receive fax content. For example, the user may designate fax recipients by typing in the recipients and/or by designating the recipients from an address book. In some instances, the user can designate a plurality of fax recipients with a single click of a group alias in the address book. But a few examples of allowing a user to designate a plurality of fax recipients are described above in relation to FIGS. 9, 11 and 13. A fax coversheet can be automatically generated and populated with at least some of the fax recipients. Several examples of exemplary broadcast fax coversheets are described above in relation to FIGS. 9-13.

Block 1504 creates a plurality of customized faxes which contain the fax content. In some implementations, the customized faxes are created by generating customized coversheets for individual fax recipients. In some instances, the relative position of the fax recipients on the coversheet may be rearranged to more prominently position a fax recipient of a specific customized fax. Examples consistent with such a process step are described above in relation to FIGS. 9-13.

### CONCLUSION

The described embodiments relate to broadcast faxing. In some embodiments, a customized fax is created for individual broadcast fax recipients without additional effort on the part of the user. Various examples of broadcast fax scenarios are described above in relation to the Windows Outlook brand messaging product for use on the Windows brand operating system. Other configurations may generate a similar functionality with other applications, such as various other dedicated fax applications and/or unified messaging applications for use on the Windows brand operating system and/or other operating systems such as Linux, and Mac OS series, among others.

Although embodiments relating to techniques for broadcast faxing have been described in language specific to structural features and/or methods, it is to be understood that the subject of the appended claims is not necessarily limited to the specific features or methods described. Rather, the specific features and methods are disclosed as exemplary implementations for enabling broadcast faxing.

1. A method, comprising:
allowing a user to designate a plurality of fax recipients to receive fax content; and,
creating a plurality of customized faxes which contain the fax content.

2. The method as recited in claim 1, wherein the allowing comprises allowing the user to designate the plurality of fax recipients in a header of a fax composition window and wherein at least some of the plurality of fax recipients from the header are automatically populated to a coversheet of the plurality of the customized faxes.

3. The method as recited in claim 1, wherein the allowing comprises allowing the user to select a single group alias which populates the plurality of fax recipients.

4. The method as recited in claim 1, wherein the creating comprises generating a customized coversheet for individual fax recipients and combining the customized coversheets with the fax content to create the plurality of customized faxes.

5. The method as recited in claim 1, wherein the creating comprises dynamically creating an individual customized fax responsive to a different individual customized fax being sent to a fax recipient.

6. The method as recited in claim 1 further comprising responsive to a single user command, sequentially faxing the plurality of customized faxes to individual fax recipients.

7. The method as recited in claim 1, wherein the allowing comprises allowing the user to designate the fax recipients in one or more of: a To field, a Courtesy copy (Cc) field, and a Blind courtesy copy (Bcc) field.

8. The method as recited in claim 7, wherein user entries in the To field, the Cc field, and/or the Bcc field constitute a distribution list, and wherein said creating comprises selecting an individual name from the distribution list and populating the individual name into a fax recipient field of a coversheet of an individual customized fax of the plurality of customized faxes.

9. One or more computer-readable media having computer-readable instructions which, when executed, implement a method, comprising:
generating a fax composition window in which a user can add content and designate a plurality of fax recipients; and,
creating a customized fax for individual fax recipients.

10. The computer readable media as recited in claim 9, wherein the fax composition window comprises a header having fields in which the user designates the plurality of fax recipients and wherein at least some of the fax recipients from the header are automatically populated to a cover sheet in the fax composition window.

11. The computer readable media as recited in claim 9 further comprising allowing a user to determine a fax status for individual fax recipients.

12. The computer readable media as recited in claim 9 further comprises enabling a user to receive a delivery receipt for customized faxes sent to individual fax recipients.

13. The computer readable media as recited in claim 9, wherein the generating comprises generating a fax composition window providing access to a unified messaging address book containing at least one email address and at least one fax number.

14. The computer readable media as recited in claim 9, wherein the creating comprises creating a unique coversheet for individual fax recipients and combining the unique coversheet with the content to create the customized fax.

15. The computer readable media as recited in claim 9, wherein the fax composition window comprises at least one field in which the user can designate fax recipients.

16. The computer readable media as recited in claim 15, wherein the coversheet shows the at least one field as well as a recipient field which contains only a single fax recipient from the at least one field.

17. A system, comprising:
means for generating a fax composition window in which a user can add content and designate a plurality of fax recipients; and,
means for creating a customized fax containing the content for an individual fax recipient.

18. A system as recited in claim 17, wherein the means for generating comprises a unified messaging application.

19. A system as recited in claim 17, wherein the means for creating is configured to dynamically create customized faxes as a faxing mechanism becomes available.

20. A system as recited in claim 19, further comprising a means for generating delivery confirmations for each of the customized faxes.
